(19) United States
(12) Patent Application Publication
(10) Pub. No.: US 2024/0305391 A1
(43) Pub. Date: Sep. 12, 2024

(54) DETERMINING CHANNEL CONDITION

(71) Applicant: Nokia Solutions and Networks Oy, Espoo (FI)

(72) Inventors: Dani Johannes KORPI, Helsinki (FI); Janne Matti Juhani HUTTUNEN, Espoo (FI); Mikko Aleksi UUSITALO, Helsinki (FI); Mikko Johannes HONKALA, Espoo (FI); Leo Mikko Johannes KARKKAINEN, Helsinki (FI)

(73) Assignee: Nokia Solutions and Networks Oy, Espoo (FI)

(21) Appl. No.: 18/546,335

(22) PCT Filed: Dec. 22, 2021
(86) PCT No.: PCT/EP2021/087292

§ 371 Date: Aug. 14, 2023

(30) Foreign Application Priority Data
Feb. 17, 2021 (FI) 20215163

(51) Int. Cl. H04B 17/345; H04L 25/02; H04W 24/08

(52) U.S. Cl. CPC H04B 17/345; H04L 25/0224; H04W 24/08

(57) ABSTRACT

An apparatus and method for determining channel condition are disclosed. The apparatus comprises: a reception radio unit having a reception radio unit antenna and a reception radio unit receiver configured to receive uplink transmissions from user equipment; and a spatially-separated transmission radio unit having a transmission radio unit antenna and a transmission radio unit transmitter configured to transmit downlink transmissions to the user equipment, the transmission radio unit having a transmission radio unit receiver configured to receive the uplink transmissions from user equipment to determine a channel condition between the transmission radio unit and the user equipment.

### TECHNOLOGICAL FIELD

Various example embodiments relate to an apparatus and method for determining channel condition.

### BACKGROUND

In wireless telecommunications networks, base stations communicate with user equipment using transmitted and received signals. To improve the decoding of these signals, the channel conditions experienced by those signals can be estimated and used to compensate for those channel conditions when transmitting those signals.

Although techniques exist for estimating channel conditions, they each have their own shortcomings. Accordingly, it is desired to provide an improved technique for determining channel conditions.

### BRIEF SUMMARY

The scope of protection sought for various embodiments of the invention is set out by the independent claims. The examples and features, if any, described in this specification that do not fall under the scope of the independent claims are to be interpreted as examples useful for understanding various embodiments of the invention.

According to various, but not necessarily all, embodiments of the invention there is provided an apparatus, comprising: a reception radio unit having at least one reception radio unit antenna and a reception radio unit receiver configured to receive uplink transmissions from user equipment; and a spatially-separated transmission radio unit having a transmission radio unit antenna and a transmission radio unit transmitter configured to transmit downlink transmissions to the user equipment, the transmission radio unit having a transmission radio unit receiver configured to receive the uplink transmissions from user equipment to determine a channel condition between the transmission radio unit and the user equipment.

The reception radio unit may comprise a reception distributed unit, the reception radio unit receiver may comprise a reception distributed unit receiver, the transmission radio unit may comprise a transmission distributed unit, the transmission radio unit antenna may comprise a transmission distributed unit antenna, the transmission radio unit transmitter may comprise a transmission distributed unit transmitter and the transmission radio unit receiver may comprise a transmission distributed unit receiver.

The transmission distributed unit receiver may be configured to determine the channel condition between the transmission distributed unit and the user equipment based on an uplink reference signal received from the user equipment.

The transmission distributed unit receiver may be configured to determine the channel condition between the transmission distributed unit and the user equipment based on at least one of Demodulation Reference Signal and a Sounding Reference Signal received from the user equipment.

The transmission distributed unit receiver may be configured to receive the uplink transmissions from each of a plurality of user equipment to determine a corresponding plurality of channel conditions between the transmission distributed unit and each of the plurality of user equipment.

The transmission distributed unit receiver may be configured to receive the uplink transmissions from each of a plurality of user equipment to determine a corresponding plurality of channel conditions between the transmission distributed unit and each of the plurality of user equipment scheduled for a downlink transmission.

The transmission distributed unit transmitter may be configured to transmit downlink transmissions to the user equipment using the channel condition determined for that user equipment.

The transmission distributed unit receiver may be configured to perform cancellation of self-interference caused by downlink transmissions when estimating the channel condition.

The transmission distributed unit receiver may be configured to determine an amount of self-interference caused by downlink transmissions and to cancel this from the uplink reference signal received from the user equipment when estimating the channel condition.

The transmission distributed unit receiver may be configured to determine an amount of self-interference caused by downlink transmissions only during reception of the uplink reference signal and to cancel this from the uplink reference signal received from the user equipment when estimating the channel condition.

The transmission distributed unit receiver may be configured to determine an amount of self-interference caused by downlink transmissions when no uplink data transmission is present and to cancel this from the uplink reference signal received from the user equipment when estimating the channel condition.

The transmission distributed unit receiver may be configured to determine an amount of self-interference caused by downlink transmissions using resource elements which have no uplink data transmission present and to cancel this from the uplink reference signal received from the user equipment when estimating the channel condition.

When resource elements in a transmission time interval each have uplink data present, the transmission distributed unit receiver may be configured to determine an amount of self-interference caused by downlink transmissions using every resource element which has downlink data transmission present and to cancel this from the uplink reference signal received from the user equipment when estimating the channel condition.

The transmission distributed unit receiver may be configured to assume that an amount of self-interference remains static for at least a transmission time interval.

The transmission distributed unit transmitter may be configured to provide a transmission signal to the transmission distributed unit antenna and to the reception distributed unit receiver to perform cancellation of self-interference caused by downlink transmissions.

According to various, but not necessarily all, embodiments of the invention there is provided an apparatus, comprising: means for receiving uplink transmissions from user equipment at a reception radio unit receiver of a reception radio unit; and means for determining a channel condition between a transmission radio unit spatially separated from the reception radio unit and the user equipment by receiving the uplink transmissions from user equipment at a transmission radio unit receiver of the transmission radio unit.

The reception radio unit may comprise a reception distributed unit, the reception radio unit receiver may comprise a reception distributed unit receiver, the transmission radio unit may comprise a transmission distributed unit, the transmission radio unit antenna may comprise a transmission distributed unit antenna, the transmission radio unit transmitter may comprise a transmission distributed unit transmitter and the transmission radio unit receiver may comprise a transmission distributed unit receiver.

The means for determining may comprise means for determining the channel condition between the transmission distributed unit and the user equipment based on an uplink reference signal received from the user equipment.

The means for determining may comprise means for determining the channel condition between the transmission distributed unit and the user equipment based on at least one of Demodulation Reference Signal and a Sounding Reference Signal received from the user equipment.

The means for determining may comprise means for determining a plurality of channel conditions between the transmission distributed unit and a corresponding plurality of user equipment based on a corresponding plurality of the uplink transmissions from each of the plurality of user equipment.

The means for determining may comprise means for determining a plurality of channel conditions between the transmission distributed unit and a corresponding plurality of user equipment scheduled for a downlink transmission based on a corresponding plurality of the uplink transmissions from each of the plurality of user equipment scheduled for a downlink transmission.

The apparatus may comprise means for transmitting downlink transmissions from the transmission distributed unit transmitter to the user equipment using the channel condition determined for that user equipment.

The apparatus may comprise means for performing cancellation of self-interference caused by downlink transmissions when estimating the channel condition.

The apparatus may comprise means for determining an amount of self-interference caused by downlink transmissions and means for cancelling this from the uplink reference signal received from the user equipment when estimating the channel condition.

The apparatus may comprise means for determining an amount of self-interference caused by downlink transmissions only during reception of the uplink reference signal and means for cancelling this from the uplink reference signal received from the user equipment when estimating the channel condition.

The apparatus may comprise means for determining an amount of self-interference caused by downlink transmissions when no uplink data transmission is present and means for cancelling this from the uplink reference signal received from the user equipment when estimating the channel condition.

The apparatus may comprise means for determining an amount of self-interference caused by downlink transmissions using resource elements which have no uplink data transmission present and means for cancelling this from the uplink reference signal received from the user equipment when estimating the channel condition.

When resource elements in a transmission time interval each have uplink data present, the apparatus may comprise means for determining an amount of self-interference caused by downlink transmissions using every resource element which has downlink data transmission present and means for cancelling this from the uplink reference signal received from the user equipment when estimating the channel condition.

The means for cancelling may assume that an amount of self-interference remains static for at least a transmission time interval.

The apparatus may comprise means for providing a transmission signal to a transmission distributed unit antenna and to the reception distributed unit receiver to perform cancellation of self-interference caused by downlink transmissions.

According to various, but not necessarily all, embodiments of the invention there is provided a method, comprising: receiving uplink transmissions from user equipment at a reception radio unit receiver of a reception radio unit; and determining a channel condition between a transmission radio unit spatially separated from the reception radio unit and the user equipment by receiving the uplink transmissions from user equipment at a transmission radio unit receiver of the transmission radio unit.

The reception radio unit may comprise a reception distributed unit, the reception radio unit receiver may comprise a reception distributed unit receive, the transmission radio unit may comprise a transmission distributed unit, the transmission radio unit antenna may comprise a transmission distributed unit antenna, the transmission radio unit transmitter may comprise a transmission distributed unit transmitter and the transmission radio unit receiver may comprise a transmission distributed unit receiver.

The determining may comprise determining the channel condition between the transmission distributed unit and the user equipment based on an uplink reference signal received from the user equipment.

The determining may comprise determining the channel condition between the transmission distributed unit and the user equipment based on at least one of Demodulation Reference Signal and a Sounding Reference Signal received from the user equipment.

The determining may comprise determining a plurality of channel conditions between the transmission distributed unit and a corresponding plurality of user equipment based on a corresponding plurality of the uplink transmissions from each of the plurality of user equipment.

The determining may comprise determining a plurality of channel conditions between the transmission distributed unit and a corresponding plurality of user equipment scheduled for a downlink transmission based on a corresponding plurality of the uplink transmissions from each of the plurality of user equipment scheduled for a downlink transmission.

The method may comprise transmitting downlink transmissions from the transmission distributed unit transmitter to the user equipment using the channel condition determined for that user equipment.

The method may comprise performing cancellation of self-interference caused by downlink transmissions when estimating the channel condition.

The method may comprise determining an amount of self-interference caused by downlink transmissions and cancelling this from the uplink reference signal received from the user equipment when estimating the channel condition.

The method may comprise determining an amount of self-interference caused by downlink transmissions only during reception of the uplink reference signal and cancelling this from the uplink reference signal received from the user equipment when estimating the channel condition.

The method may comprise determining an amount of self-interference caused by downlink transmissions when no uplink data transmission is present and cancelling this from the uplink reference signal received from the user equipment when estimating the channel condition.

The method may comprise determining an amount of self-interference caused by downlink transmissions using resource elements which have no uplink data transmission present and cancelling this from the uplink reference signal received from the user equipment when estimating the channel condition.

When resource elements in a transmission time interval each have uplink data present, the method may comprise determining an amount of self-interference caused by downlink transmissions using every resource element which has downlink data transmission present and cancelling this from the uplink reference signal received from the user equipment when estimating the channel condition.

The estimating may assume that an amount of self-interference remains static for at least a transmission time interval.

The method may comprise providing a transmission signal to a transmission distributed unit antenna and to the reception distributed unit receiver to perform cancellation of self-interference caused by downlink transmissions.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function. Where an apparatus feature is described as being configured to provide a function, it will be appreciated that this may include an apparatus feature such as circuitry which provides that function.

### BRIEF DESCRIPTION

Some example embodiments will now be described with reference to the accompanying drawings in which:

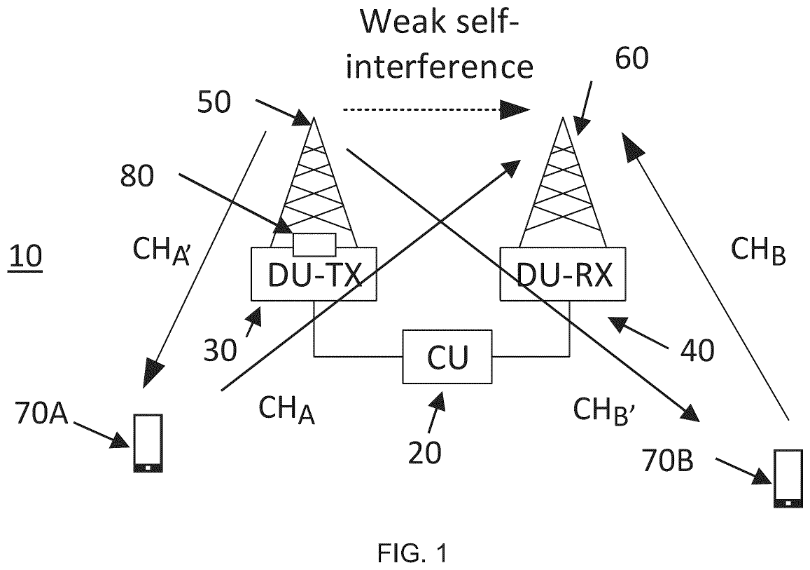

FIG. 1 illustrates schematically some components of a telecommunication network according to one embodiment;

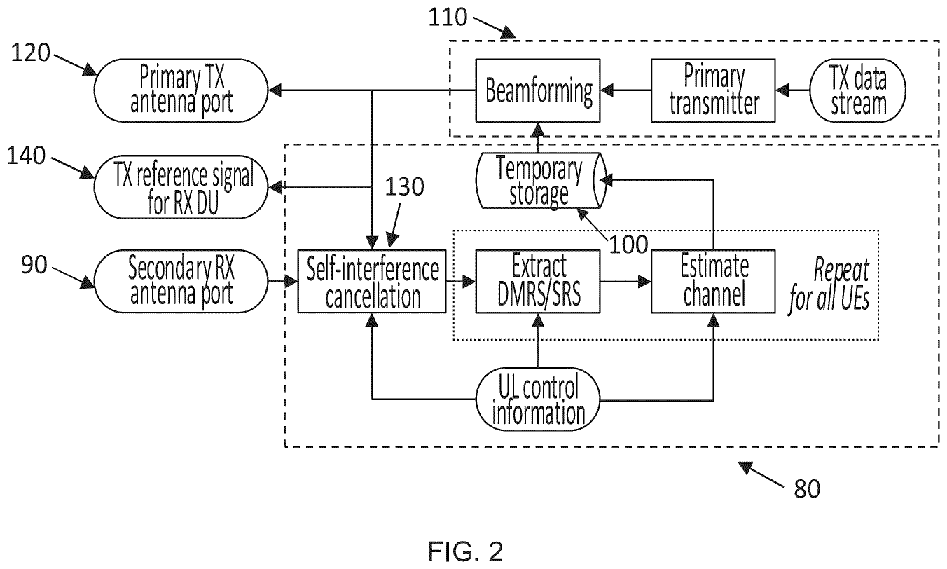

FIG. 2 illustrates schematically operating logic of a transmission distributed unit according to one embodiment;

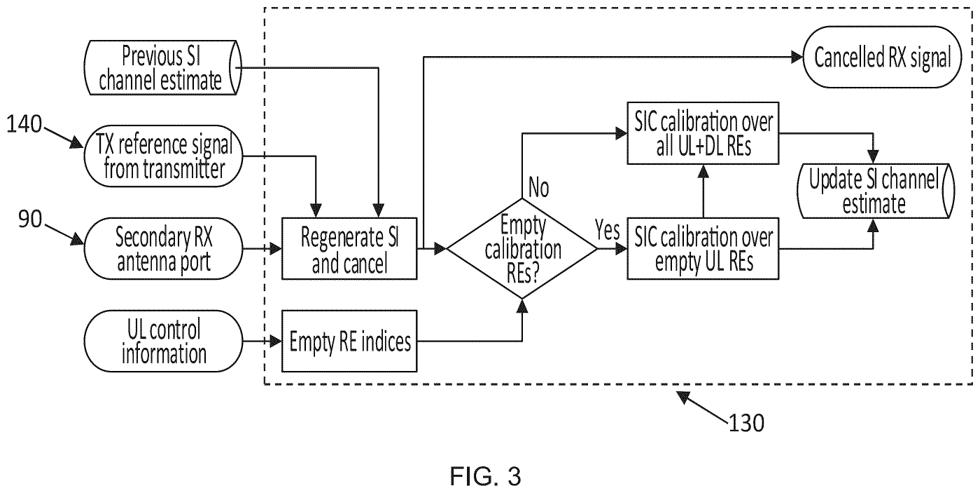

FIG. 3 illustrates schematically operating logic of a self interference canceller according to one embodiment;

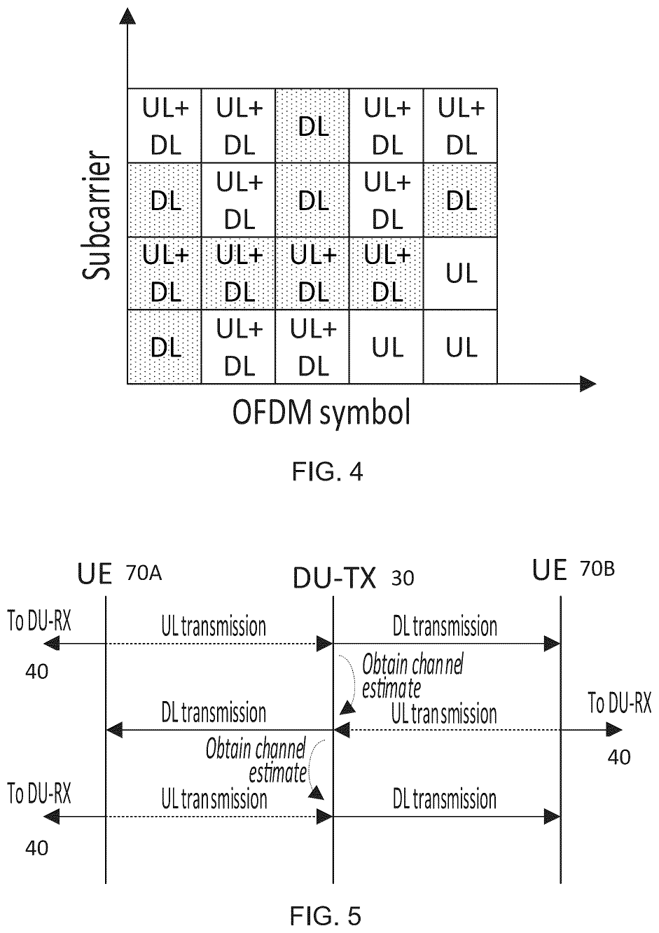

FIG. 4 illustrates resource elements used for self interference canceller calibration according to one embodiment; and

FIG. 5 illustrates timing of uplink and downlink transmissions when serving two user equipment within the cell.

### DETAILED DESCRIPTION

Before discussing the example embodiments in any more detail, first an overview will be provided. Some embodiments provide a technique where an apparatus has a reception radio unit having at least one reception antenna which receives transmissions from user equipment. The reception antenna is located away from a transmission antenna of a transmission radio unit. The transmission radio unit also has a receiver which receives those transmissions from the user equipment. This enables the transmission radio unit also to determine the channel condition between the transmission radio unit and the user equipment based on those transmissions received from that user equipment. The channel condition can then be used for subsequent transmissions to that user equipment. Reference signals from the user equipment may be used to determine the channel condition. Self-interference (SI) cancellation may be performed by the transmission distributed unit to reduce interference experienced by the receiver when receiving transmission from the user equipment caused by transmissions from the transmission radio unit. Those transmissions can also be conveyed to the reception radio unit to assist in self-interference cancellation performed by the reception radio unit.

Some embodiments relate to inband full-duplex (IBFD) where transmitted and received signals are fully overlapping in time and frequency, in contrast to other duplexing mechanisms where they are divided either within separate time slots (as used in time division duplexing (TDD)) or separate frequency bands (as used in frequency division duplexing (FDD)). IBFD results in large amounts of SI, which benefits from passive and active cancellation mechanisms. For this reason, it is desirable to separate the transmitting and receiving arrays by a few meters, since the resulting increased path loss would greatly reduce the SI power. This allows the network to utilize IBFD in the network side with only little additional computational complexity from SI cancellers.

### Network Overview

FIG. 1 illustrates schematically some components of a telecommunication network according to one embodiment. In this example, a 5G gNodeB (gNB) 10 (although other base stations are possible or even other radio systems having separated or dedicated transmission radio units, each having their own antenna(s)), comprises a central unit (CU) 20, a transmission distributed unit (DU) 30 having a transmission antenna 50 for serving downlink (DL) communication and a reception distributed unit 40 having a reception antenna 60 serving uplink (UL) communication. In this example, the user equipment (UEs) 70A, 70B are assumed to be legacy half-duplex radios (although other user equipment are possible), but the IBFD capability of the gNB 10 allows for serving the UL and DL to UEs 70A, 70B simultaneously. As mentioned above, separation of the transmitting and receiving DUs 30, 40 and their associated antennas 50, 60 makes the resulting problem of SI cancellation considerably easier since the power of the DL transmissions from the antenna 50 received by the antenna 60 are reduced dramatically. Another relevant multiplexing approach, suffering from similar SI, is to divide the UL and DL resources on a per-subcarrier basis. This means that there would be no interference between the UEs (assuming moderate Doppler shifts), but the transmission distributed unit 50 and reception distributed unit 40 would still suffer from SI because it would be possible to separate the transmission (TX) and reception (RX) signals only after the fast Fourier transform (FFT). In this case it would therefore be also beneficial to separate the reception distributed unit 40 and transmission distributed unit 50 as illustrated in FIG. 1.

However, spatially separating the antennas 50, 60 results in a difference in the channel state between the UEs 70A, 70B and the transmission and reception DUs 30, 40. In particular, the channel state CH_{A} between the UE 70A and the antenna 60 differs from the channel state CH_{A′} between the UE 70A and the antenna 50. Likewise, the channel state CH_{B} between the UE 70B and the antenna 60 differs from the channel state CH_{B′} between the UE 70B and the antenna 50. This means that if the legacy approach of determining the channel state CH_{A}, CH_{B} by the reception DU 40 from uplink transmissions and then using that channel state for downlink transmission is employed then those downlink transmissions are sub-optimal since the CH_{A′}, CH_{B′} will be different. In other words, a problem with separating the reception antenna 60 and transmission antenna 50 into different DUs as described above is the loss of channel information at the TX side. Namely, with a co-located reception antenna 60 and transmission antenna 50, the channel estimate of the received signal can directly be applied to TX-side beamforming due to the reciprocity of the channel. However, if the transmission antenna 50 is spatially separated from the reception antenna 60, the only way to obtain channel information is via UE feedback. This hinders the beamforming accuracy and introduces considerable overhead.

Some embodiments address this missing channel information by introducing a ‘lightweight’ or reduced functionality channel estimation receiver 80 to the transmission DU 30. This provides the benefits of IBFD with only minor SI cancellation requirements, while still facilitating accurate transmission or downlink beamforming.

### Transmission Distributed Unit

FIG. 2 illustrates schematically operating logic of the transmission DU 30 according to one embodiment. The task of the channel estimation receiver 80 is to listen for the UL transmissions of the UEs 70A, 70B, typically using the antenna 50 via a secondary reception antenna port 90, and typically to extract the demodulation reference signals (DMRS) and/or sounding reference signals (SRS) and/or other signals to be used for channel estimation. The channel estimates of all scheduled UEs are then stored temporarily in temporary storage 100 such that its transmitter 100 can use them for beamforming the upcoming DL transmissions sent via a transmission antenna port 120.

Although the reception DU 40 suffers from reduced levels of SI due to spatial separation from the transmission DU 30, the channel estimation receiver 80 at the transmission DU 30 experiences stronger SI since it is utilizing a co-located or even the same antenna array 50 as the transmitter 110. However, SI cancellation in the channel estimation receiver 80 is considerably easier than in a regular receiver, because it suffices to cancel only the DMRS/SRS part of the received data. The remaining parts can be used for calibrating a SI canceller 130 or simply discarded. Moreover, the channel estimation receiver 80 can opportunistically utilize such portions of the data signal where there is no UL transmission present and use that for even more accurate SI canceller 130 calibration.

The transmission side of the transmission DU 30 is identical to that of a regular transmission DU, with the exception that the transmitted antenna signal is also routed to the SI canceller 130 at the channel estimation receiver 80 and to the reception DU 40 via a port 140. The transmission DU 50 may also include some passive/active analogue SI cancellation stages, if necessary. In the special case where the UL and DL are allocated different subcarriers, no digital SI cancellation is needed. In such a case the DL subcarriers can simply be discarded after the fast Fourier transform (FFT) operation. Moreover, the source of the channel information for beamforming has also no implications in the transmission side, this being of course different in this embodiment where the channel information is obtained from the channel estimation receiver 80.

### Self Interference Canceller

Now turning to the SI cancellation and channel estimation part of the channel estimation receiver 80 in more detail. Its task is to receive the UL transmissions of UEs 70A, 70B, which occur simultaneously with DL transmissions to the UEs 70A, 70B, either on overlapping subcarriers or on adjacent subcarriers. In the former IBFD case, the channel estimation receiver 80 ought first to cancel the SI. In the example embodiment, it is assumed that the channel estimation receiver 80 is separated from the transmission path with circulators, which provides sufficient passive isolation for carrying out active SI cancellation only in the digital domain. Denoting the transmitted MIMO symbols at subcarrier i and OFDM symbol j with xᵢⱼ and the observed symbols with y_{ij,SI}, the digital cancellation procedure (with frequency domain notation) can be carried out in principle by yᵢⱼ=y_{ij.SI}−Ĥᵢ xᵢⱼ, where Ĥᵢ is the estimate of the SI channel matrix at the ith subcarrier and yᵢⱼ is the received signal without SI. Since the SI channel occurs between the two fixed antennas 50, 60 and any moving obstacles are far away from the link, we can assume that the SI channel remains static for the duration of the whole transmission time interval (TTI) (in reality it can be expected to be static for even longer periods of time).

Important to the SI canceller 130 is the accuracy of Ĥᵢ, which determines how efficiently the SI can be suppressed. To maximize the accuracy, the SI channel should be estimated when no UL transmissions are present, if possible. Namely, it is likely that in many TTIs there are resource elements (REs) without scheduled UL traffic, which should be harnessed by the SI canceller 130.

FIG. 3 illustrates schematically operating logic of the SI canceller 130 employing this type of opportunistic SI channel estimation, when operating in the frequency domain (it will be appreciated that a similar procedure is possible also with time-domain cancellers). In such a case where there are no UL-free REs, a fallback solution is to tolerate the UL interference and use all available REs for estimating the SI channel. In this case robustness is achieved by utilizing all the symbols for SI channel estimation. FIG. 4 illustrates this for an example scenario, where the REs used for SI canceller 130 calibration for each OFDM subcarrier are highlighted with grey colour.

Considering the SI canceller 130 calibration procedure more formally, let us denote the stored SI channel estimate for an individual subcarrier by Ĥᵢ, where i is the subcarrier index (recalling that the SI channel is static for the duration of a single slot). The first step is to determine the symbol indices over which there are no UL transmissions (in the considered subcarrier). Denoting the set of these indices by E, the SI calibration procedure over a single subcarrier can be written as follows

$$\{ \begin{matrix}{\hat{H}}_{i} = {\hat{H}}_{i} + μ ( {y}_{ij . SI} - {\hat{H}}_{i} {x}_{ij} ) {x}_{ij}^{H} , j ϵ E , if card ( E ) > 0 \\ {\hat{H}}_{i} = {\hat{H}}_{i} + μ ( {y}_{ij . SI} - {\hat{H}}_{i} {x}_{ij} ) {x}_{ij}^{H} , j ϵ S , if card ( E ) = 0\end{matrix}$$

where μ is the learning rate, card(E) denotes the cardinality of set E, and S is the set of all OFDM symbols within the TTI or slot. The updated SI channel estimate is then stored to memory and used for cancelling the SI in the next slot by yᵢⱼ=y_{ij.SI}−Ĥᵢxᵢⱼ, as already shown above. There can also be an additional trigger for initiating SI canceller 130 calibration if it is not necessary to do it in every slot.

Returning to FIG. 3 and as illustrated in FIG. 5, after the SI canceller 130 uses the SI channel estimate to remove SI, the SRS or DMRS portion of the received (and in the case of IBFD, cancelled) signal yᵢⱼ is extracted, typically for each UE scheduled for DL transmission. This is then processed to form the channel estimate for the UL UEs, which are fed to the beamformer to be used for calculating the beamforming coefficients for subsequent DL transmissions with that UE. As mentioned above, the channel estimation and beamforming parts are carried out similar to conventional transmitters. In particular, FIG. 5 illustrates the timing of the UL and DL transmissions when serving two UEs 70A, 70B within the cell. The transmission DU 50 always listens to the transmission of the UL UE when serving the DL UE, and then utilizes the obtained channel estimate for beamforming when that particular UL UE is served in DL.

Hence, it can be seen that some embodiments introduce a lightweight channel estimation receiver, which facilitates the use of spatially separated transmission and reception DUs (in a full-duplex manner). Within the channel estimation receiver, SI cancellation is typically only applied to the DMRS/SRS part of the signal, thereby reducing the overall complexity. Also, there is a significant probability that the data-carrying part of the signal has portions without overlapping UL transmissions, which can be used for more accurate SI canceller calibration. This has a number of advantages: harnessing the higher spectral efficiency of IBFD with minimal additional cost; reduced complexity compared to implementing a co-located IBFD transmission and reception DU; co-locating would require highly accurate SI cancellation all the time, unlike in the channel estimation receiver; the same principle can be applied to any transmitting element, which requires channel knowledge for beamforming but does not require a full receiver.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus, comprising:
a reception radio unit having at least one reception radio unit antenna and a reception radio unit receiver configured to receive uplink transmissions from user equipment; and
a spatially-separated transmission radio unit having a transmission radio unit antenna and a transmission radio unit transmitter configured to transmit downlink transmissions to said user equipment, said transmission radio unit having a transmission radio unit receiver configured to receive said uplink transmissions from user equipment to determine a channel condition between said transmission radio unit and said user equipment.

2. The apparatus of claim 1, wherein said reception radio unit comprises a reception distributed unit, said reception radio unit receiver comprises a reception distributed unit receiver, said transmission radio unit comprises a transmission distributed unit, said transmission radio unit antenna comprises a transmission distributed unit antenna, said transmission radio unit transmitter comprises a transmission distributed unit transmitter and said transmission radio unit receiver comprises a transmission distributed unit receiver.

3. The apparatus of claim 2, wherein said transmission distributed unit receiver is configured to determine said channel condition between said transmission distributed unit and said user equipment based on an uplink reference signal received from said user equipment.

4. The apparatus of claim 2, wherein said transmission distributed unit receiver is configured to determine said channel condition between said transmission distributed unit and said user equipment based on at least one of Demodulation Reference Signal and a Sounding Reference Signal received from said user equipment.

5. The apparatus of any one of claim 2, wherein said transmission distributed unit receiver is configured to receive said uplink transmissions from each of a plurality of user equipment to determine a corresponding plurality of channel conditions between said transmission distributed unit and each of said plurality of user equipment.

6. The apparatus of any one of claim 2, wherein said transmission distributed unit receiver is configured to receive said uplink transmissions from each of a plurality of user equipment to determine a corresponding plurality of channel conditions between said transmission distributed unit and each of said plurality of user equipment scheduled for a downlink transmission.

7. The apparatus of any one of claim 2, wherein said transmission distributed unit transmitter is configured to transmit downlink transmissions to said user equipment using said channel condition determined for that user equipment.

8. The apparatus of any one of claim 2, wherein said transmission distributed unit receiver is configured to perform cancellation of self-interference caused by downlink transmissions when estimating said channel condition.

9. The apparatus of any one of claim 2, wherein said transmission distributed unit receiver is configured to determine an amount of self-interference caused by downlink transmissions and to cancel this from said uplink reference signal received from said user equipment when estimating said channel condition.

10. The apparatus of any one of claim 2, wherein said transmission distributed unit receiver is configured to determine an amount of self-interference caused by downlink transmissions only during reception of said uplink reference signal and to cancel this from said uplink reference signal received from said user equipment when estimating said channel condition.

11. The apparatus of any one of claim 2, wherein said transmission distributed unit receiver is configured to determine an amount of self-interference caused by downlink transmissions when no uplink data transmission is present and to cancel this from said uplink reference signal received from said user equipment when estimating said channel condition.

12. The apparatus of any one of claim 2, wherein said transmission distributed unit receiver is configured to determine an amount of self-interference caused by downlink transmissions using resource elements which have no uplink data transmission present and to cancel this from said uplink reference signal received from said user equipment when estimating said channel condition.

13. The apparatus of any one of claim 2, wherein when resource elements in a transmission time interval each have uplink data present, said transmission distributed unit receiver is configured to determine an amount of self-interference caused by downlink transmissions using every resource element which has downlink data transmission present and to cancel this from said uplink reference signal received from said user equipment when estimating said channel condition.

14. The apparatus of any one of claim 2, wherein said transmission distributed unit receiver is configured to assume that an amount of self-interference remains static for at least a transmission time interval.

15.-29. (canceled)

30. A method, comprising:
receiving uplink transmissions from user equipment at a reception radio unit receiver of a reception radio unit; and
determining a channel condition between a transmission radio unit spatially separated from said reception radio unit and said user equipment by receiving said uplink transmissions from user equipment at a transmission radio unit receiver of said transmission radio unit.

31.-45. (canceled)
